(19) United States
(12) Patent Application Publication
(10) Pub. No.: US 2026/0183579 A1
(43) Pub. Date: Jul. 2, 2026

(54) NECK-HANGING AIR PURIFIER

(71) Applicant: Guangzhou Fengruijing Technology Device Co., Ltd., Guangzhou (CN)

(72) Inventor: Zhongshu Xie, Guangzhou (CN)

(21) Appl. No.: 19/050,786

(22) Filed: Feb. 11, 2025

(30) Foreign Application Priority Data
Dec. 31, 2024 (CN) 202411990843.0
Dec. 31, 2024 (CN) 202423319264.1

(51) Int. Cl. A62B 9/04; A62B 23/02; F04D 25/08

(52) U.S. Cl. CPC A62B 9/04; A62B 23/02; F04D 25/08

(57) ABSTRACT

The present invention provides a neck-hanging air purifier, and relates to the technical field of air purifiers. The neck-hanging air purifier includes a neck-hanging body and an installation shell provided on the neck-hanging body. The installation shell is internally provided with a turbo fan and a filter screen. An air inlet hole is provided on one side, close to the turbo fan, of the installation shell. An air outlet is provided on one side, close to the filter screen, of the installation shell. By adopting the present invention, it may be hung around the user's neck, does not require an external power supply, is very portable, and has no air transmission equipment such as pipes, thus not causing inconvenience to a user; and moreover, it may blow filtered air directly to the user's mouth and nose at close range for the user to breathe, thus avoiding purifying the entire space.

### CROSS-REFERENCE TO RELATED APPLICATIONS

This is a U.S. patent application which claims the priority and benefit of Chinese Patent Application Number 202411990843.0 and Application Number 202423319264.1, filed on Dec. 31, 2024, the disclosure of which is incorporated herein by reference in its entirety.

### TECHNICAL FIELD

The present invention relates to the technical field of air purifiers, and specifically relates to a neck-hanging air purifier.

### BACKGROUND

At present, respiratory diseases occur frequently in primary and secondary schools. The main reason is that the area in classrooms is small, the number of children is large, and children are underdeveloped and have low immunity, so that respiratory diseases often spread within a certain range, affecting children's physical and mental health.

Existing air purifiers using the filtration technology are effective, but classrooms are generally not equipped with large public air purifiers. Large air purifiers are bulky and cannot be carried by individuals. Existing desktop air purifiers have small cadr (Clean Air Delivery Rate), making it difficult to purify the entire room. In addition, they also basically need to be plugged in power supplies, which is not available on the desks in the classrooms, making it inconvenient to plug them in the power supplies.

In the prior art, there are air purifiers that can be worn on the body and adopt the filtration technology, mainly PAPR air purifiers. However, their appearances are peculiar and attract attention. In addition, they have air transmission pipes, making it inconvenient to carry. They are not suitable for students to use.

### SUMMARY

The objective of the present invention is to provide a neck-hanging air purifier that can provide solutions in view of the shortcomings of the prior art. The neck-hanging air purifier may be hung around the user's neck, does not require an external power supply, is very portable, and has no air transmission equipment such as pipes, thus not causing inconvenience to the user; and moreover, the neck-hanging air purifier may blow filtered air directly to the user's mouth and nose at close range for the user to breathe, thus avoiding purifying the entire space.

Technical solutions adopted by the present invention are as follows.

Embodiments of the present application provide a neck-hanging air purifier, including a neck-hanging body and an installation shell provided on the neck-hanging body, the installation shell being internally provided with a turbo fan and a filter screen, an air inlet hole being provided on one side, close to the turbo fan, of the installation shell, and an air outlet being provided on one side, close to the filter screen, of the installation shell.

Further, in some embodiments of the present invention, the installation shell is provided with a protective mesh cover located at the air outlet.

Further, in some embodiments of the present invention, the protective mesh cover and the air outlet are both circular, the installation shell is provided with a plurality of clamping bumps located at the air outlet, and a side wall of the protective mesh cover is provided with a plurality of L-shaped clamping grooves; and the clamping bumps correspond to the clamping grooves one by one, and the clamping bumps are embedded into the clamping grooves.

Further, in some embodiments of the present invention, the neck-hanging air purifier further includes an indicator rod, the protective mesh cover being provided with an insertion hole, and one end of the indicator rod being inserted into the insertion hole.

Further, in some embodiments of the present invention, the neck-hanging body is provided with an installation box, the installation box is internally provided with a battery, and the battery is electrically connected to the turbo fan.

Further, in some embodiments of the present invention, the neck-hanging body is U-shaped, and the installation shell and the installation box are respectively located at two ends of the neck-hanging body.

Further, in some embodiments of the present invention, connecting rods are provided at two ends of the installation shell, and the installation shell and the installation box are respectively located on the connecting rods.

Further, in some embodiments of the present invention, a blocking cover is provided on one side, close to the turbo fan, of the installation shell, and the blocking cover is provided with a plurality of clamping hooks; and a side wall of the installation shell is provided with a plurality of clamping holes, the clamping hooks are embedded into the clamping holes, the blocking cover is spaced apart from the installation shell, and the air inlet hole is formed between the blocking cover and the installation shell.

Compared with the prior art, the embodiments of the present invention at least have the following advantages or beneficial effects.

Embodiments of the present invention provide a neck-hanging air purifier, including a neck-hanging body and an installation shell provided on the neck-hanging body, the installation shell being internally provided with a turbo fan and a filter screen, an air inlet hole being provided on one side, close to the turbo fan, of the installation shell, and an air outlet being provided on one side, close to the filter screen, of the installation shell. The neck-hanging air purifier may be hung around the user's neck, does not require an external power supply, is very portable, and has no air transmission equipment such as pipes, thus not causing inconvenience to the user; and moreover, the neck-hanging air purifier may blow filtered air directly to the user's mouth and nose at close range for the user to breathe, thus avoiding purifying the entire space.

### BRIEF DESCRIPTION OF DRAWINGS

In order to explain the technical solutions of the embodiments of the present invention more clearly, drawings required to be used in the embodiments are briefly introduced below. It should be understood that the following drawings only show some embodiments of the present invention and therefore should not be regarded as limitations of the scope. For persons of ordinary skill in the art, other relevant drawings can also be obtained without exerting creative efforts according to these drawings.

FIG. 1 is a schematic structural diagram 1 of a neck-hanging air purifier provided in an embodiment of the present invention;

FIG. 2 is a schematic structural diagram 2 of a neck-hanging air purifier provided in an embodiment of the present invention;

FIG. 3 is a schematic structural diagram of a position of an installation shell provided in an embodiment of the present invention;

FIG. 4 is an exploded diagram 1 of a position of an installation shell provided in an embodiment of the present invention;

FIG. 5 is an exploded diagram 2 of a position of an installation shell provided in an embodiment of the present invention;

FIG. 6 is a schematic structural diagram of a protective mesh cover provided in an embodiment of the present invention;

FIG. 7 is a schematic structural diagram of an interior of an installation shell provided in an embodiment of the present invention;

FIG. 8 is a schematic structural diagram of a blocking cover provided in an embodiment of the present invention; and

FIG. 9 is an exploded diagram of an installation box provided in an embodiment of the present invention.

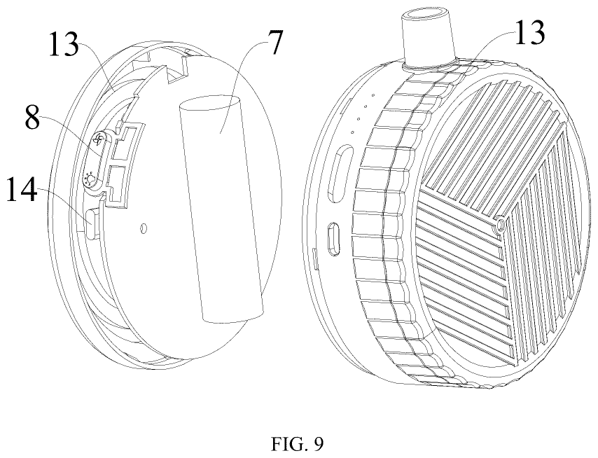

Reference signs: 1—Neck-hanging body; 2—Installation shell; 3—Turbo fan; 4—Filter screen; 5—Air inlet hole; 6—Air outlet; 7—Battery; 8—Control switch; 9—Protective mesh cover; 10 —Clamping bump; 11—Clamping groove; 12—Connecting rod; 13—Installation box; 14—Charging head; 15—Indicator rod; 16—Insertion hole; 17—Blocking cover; 18—Clamping hook; 19—Clamping hole; 20—Indicator light.

### DESCRIPTION OF EMBODIMENTS

In order to make the purpose, technical solutions and advantages of the embodiments of the present invention clearer, the technical solutions in the embodiments of the present invention are described clearly and completely below in conjunction with the drawings in the embodiments of the present invention. Obviously, the described embodiments are only a part of the embodiments of the present invention, rather than all of the embodiments. Components in the embodiments of the present invention generally described and illustrated in the drawings herein may be arranged and designed in a variety of different configurations.

Therefore, the following detailed description of the embodiments of the present invention provided in the drawings is not intended to limit the scope of the present invention claimed for protection, but only shows selected embodiments of the present invention. On the basis of the embodiments of the present invention, all other embodiments obtained by persons of ordinary skill in the art without exerting creative efforts should fall within the scope of protection of the present invention.

It should be noted that similar reference numerals and letters represent similar items in the following drawings. Therefore, once an item is defined in one figure, the item is not further defined and explained in subsequent figures.

In the description of the embodiments of the present invention, it should be noted that orientation or position relationships indicated by terms, such as “center”, “up”, “down”, “left”, “right”, “vertical”, “horizontal”, “inside” and “outside”, are orientation or position relationships based on the drawings, or orientation or position relationships when a product of the present invention is usually placed during use, only to facilitate the description of the present invention and simplify the description, rather than to indicate or imply that a device or an element referred to needs to have a specific orientation or be constructed and operated in a specific orientation, and therefore shall not be understood as limitations to the present invention. In addition, terms, such as “first” and “second”, are only used to differentiate the description and shall not be understood as indicating or implying relative importance.

In addition, terms, such as “horizontal” and “vertical”, do not mean that a component is required to be absolutely horizontal or vertical, while the component can be slightly tilted. For example, the “horizontal” only means that a direction is more horizontal than the “vertical”, and does not mean that a structure needs to be completely horizontal, while the structure can be slightly tilted.

In the description of the embodiments of the present invention, it should also be noted that, unless otherwise clearly stated and limited, terms, such as “arrange” and “connect”, should be understood in a broad sense. For example, a fixed connection, a detachable connection, or an integral connection may be used; a mechanical connection or an electrical connection may be used; and a direct connection, an indirect connection through an intermediate medium, or an internal connection between two elements may be used. For persons of ordinary skill in the art, the above terms may be understood to have specific meanings in the present invention according to specific circumstances.

### EMBODIMENT

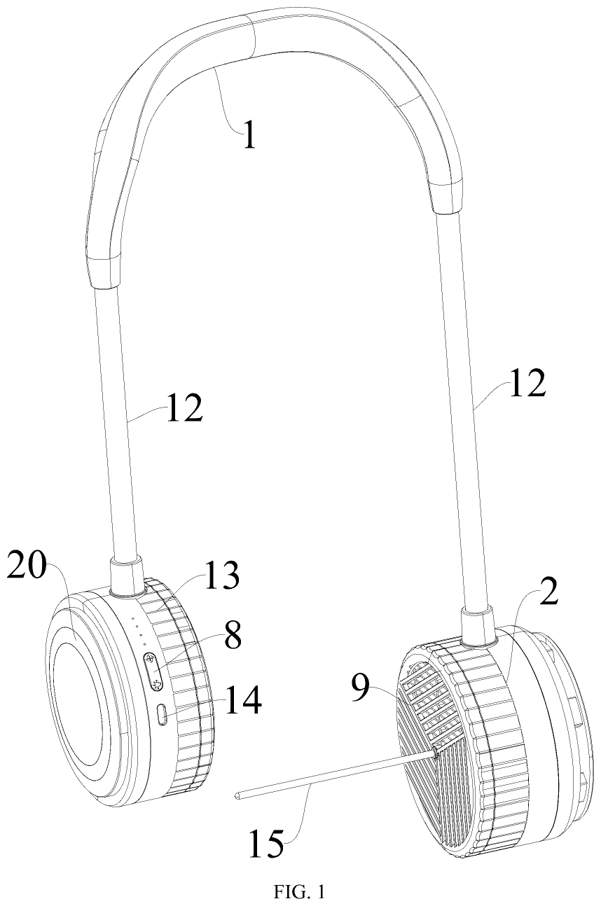

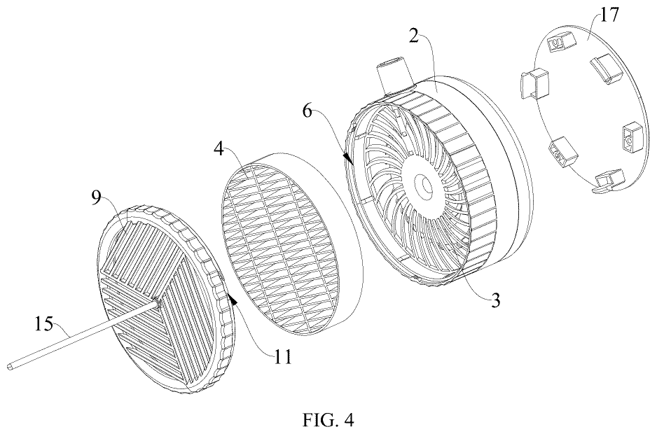

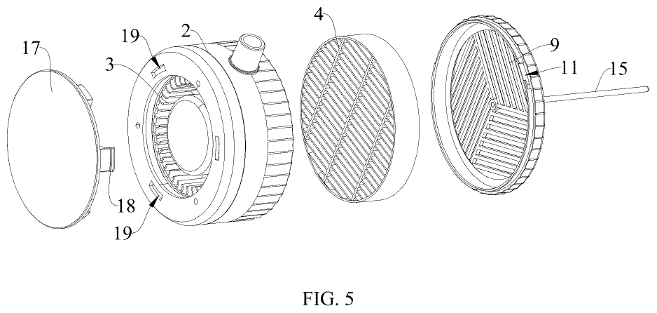

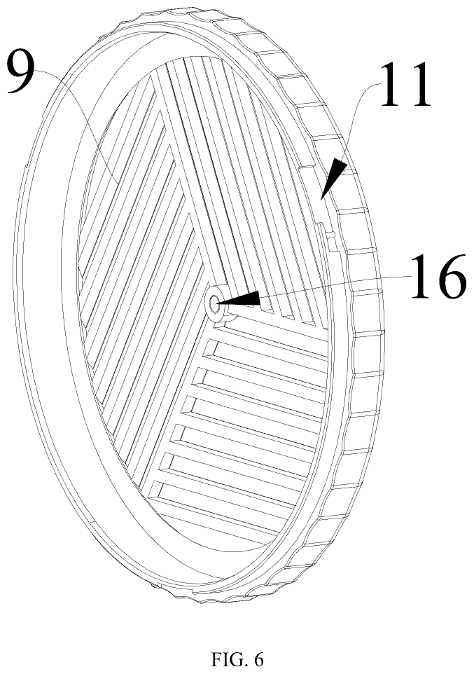

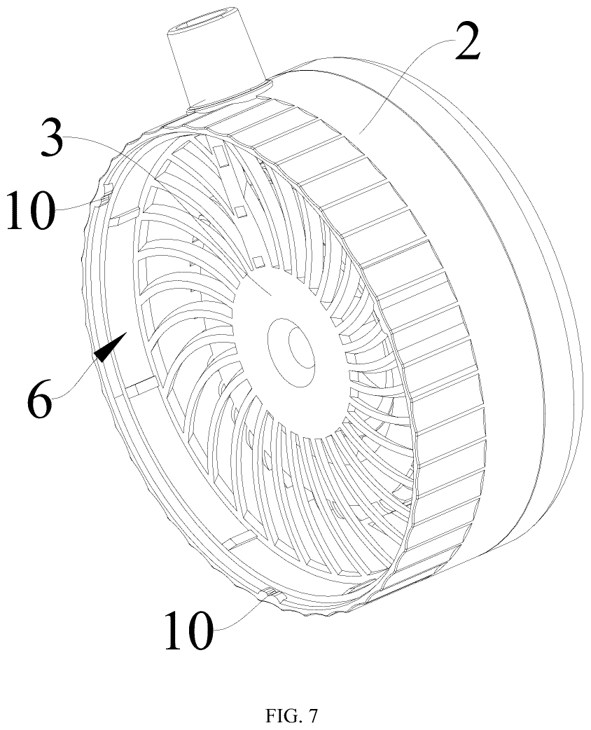

Referring to FIG. 1 to FIG. 7, the present embodiment provides a neck-hanging air purifier, including a neck-hanging body 1 and an installation shell 2 provided on the neck-hanging body 1, the installation shell 2 being internally provided with a turbo fan 3 and a filter screen 4, and the filter screen 4 of the present embodiment adopting an HEPA filter screen; and an air inlet hole 5 being provided on one side, close to the turbo fan 3, of the installation shell 2, and an air outlet 6 being provided on one side, close to the filter screen 4, of the installation shell 2.

The neck-hanging body 1 is provided with an installation box 13, the installation box 13 is internally provided with a battery 7, the battery 7 is electrically connected to the turbo fan 3, and the battery 7 is used to supply power to the turbo fan 3. Optionally, in the present embodiment, a corresponding control switch 8, charging head 14 and indicator light 20 may be provided on the installation box 13. The charging head 14 is used to connect a charger to charge the battery 7, the control switch 8 is used to control start and stop of the turbo fan 3, and the indicator light 20 is used to indicate when in use.

In actual use, the user can wear the neck-hanging body 1 around his or her neck, the position of the air outlet 6 of the installation shell 2 roughly faces the user's mouth and nose, when the turbo fan 3 is started, the turbo fan 3 will suck outside air from the air inlet hole 5 and blow the air through the filter screen 4, and the air is filtered by the filter screen 4 and then blown out from the air outlet 6 and toward the user's mouth and nose, so that the user can breathe the filtered air, and the clear air is breathed directly, thus avoiding mixing with dirty indoor air.

In this way, the neck-hanging air purifier provided by the present application may be hung around the user's neck, does not require an external power supply, is very portable, and has no air transmission equipment such as pipes, thus not causing inconvenience to the user; and moreover, the neck-hanging air purifier may blow filtered air directly to the user's mouth and nose at close range for the user to breathe, thus avoiding purifying the entire space. Moreover, the neck-hanging air purifier provided by the present application has a simple appearance, which is very similar to a headphone, does not attract extra attention, and is relatively low-key.

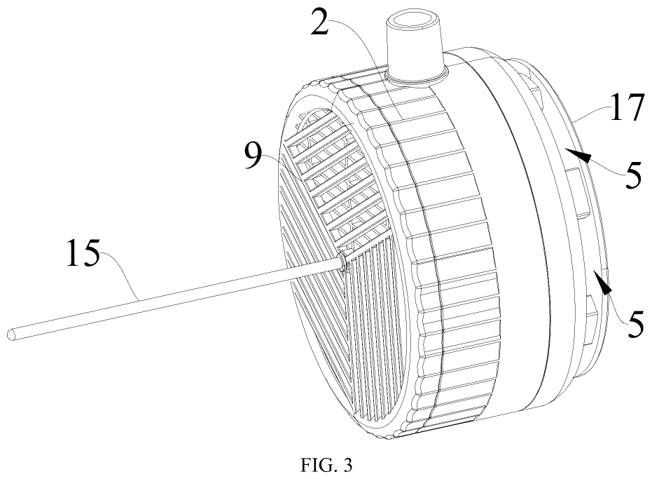

As shown in FIG. 3 to FIG. 7, in some embodiments of the present invention, the installation shell 2 is provided with a protective mesh cover 9 at the air outlet 6. The protective mesh cover 9 and the air outlet 6 are both circular, the installation shell 2 is provided with a plurality of clamping bumps 10 located at the air outlet 6, and a side wall of the protective mesh cover 9 is provided with a plurality of L-shaped clamping grooves 11; and the clamping bumps 10 correspond to the clamping grooves 11 one by one, and the clamping bumps 10 are embedded into the clamping grooves 11.

According to the present invention, by providing the protective mesh cover 9, the filter screen 4 and other structures inside the installation shell 2 may be shielded by the protective mesh cover 9 to prevent the filter screen 4 from being touched. Moreover, by providing a plurality of L-shaped clamping grooves 11 on the side wall of the protective mesh cover 9, it is convenient to install the protective mesh cover 9 on the installation shell 2 and to remove the protective mesh cover 9 from the installation shell 2. When the protective mesh cover 9 is installed, all that is needed is to align openings of the clamping grooves 11 of the protective mesh cover 9 with the clamping bumps 10, the clamping bumps 10 are embedded into the clamping grooves 11 by moving the protective mesh cover 9, and then the protective mesh cover 9 is rotated for clamping and locking.

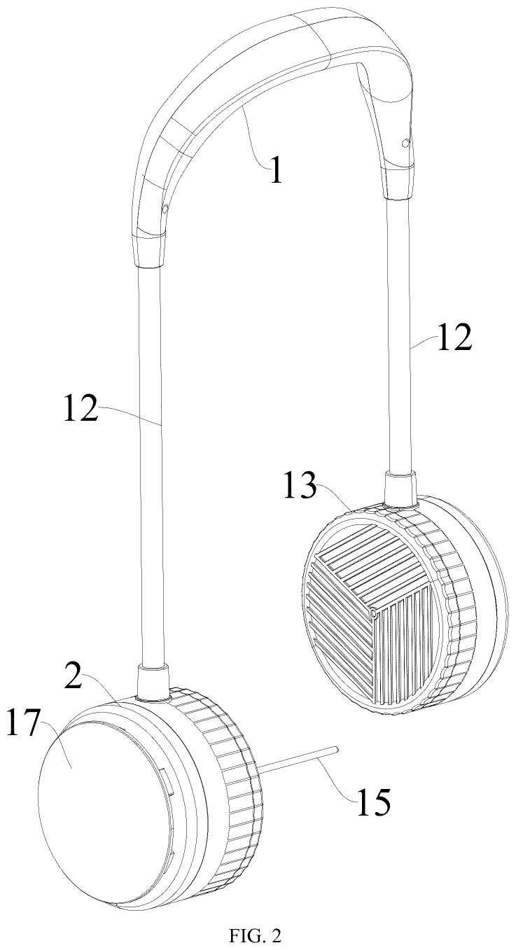

As shown in FIG. 1 to FIG. 2, in some embodiments of the present invention, the neck-hanging body 1 is U-shaped, and the installation shell 2 and the installation box 13 are respectively located at two ends of the neck-hanging body 1. This makes it convenient for the neck-hanging body 1 to be worn around the user's neck.

As shown in FIG. 1 to FIG. 2, in some embodiments of the present invention, connecting rods 12 are provided at two ends of the installation shell 2, and the installation shell 2 and the installation box 13 are respectively located on the connecting rods 12. According to the present invention, by providing the connecting rods 12, the connecting rods 12 may be a metal hose used in existing desk lamps and neck-hanging fans. In this way, the blowing angle of the air outlet 6 may be adjusted through the deformation of the connecting rods 12, facilitating blowing the filtered air to the user's mouth and nose.

As shown in FIG. 1 to FIG. 5, in some embodiments of the present invention, the neck-hanging air purifier further includes an indicator rod 15, the protective mesh cover 9 being provided with an insertion hole 16, and one end of the indicator rod 15 being inserted into the insertion hole 16.

According to the present invention, by providing the indicator rod 15, when a greenhand wears the neck-hanging air purifier, one end of the indicator rod 15 may be inserted into the insertion hole 16, so that the blowing direction of the protective mesh cover 9 may be judged by the direction of the indicator rod 15, and whether the distance at the position of the protective mesh cover 9 is adjusted in place is judged by an interval between the indicator light 15 and the user′ nose. That is, by adjusting the installation shell 2, the indicator rod 15 is roughly aligned with the user's nose, and when the indicator rod 15 is roughly contacted with the user's nose, the air outlet 6 will not be too far away from the nose at this time, and therefore, the effect is better.

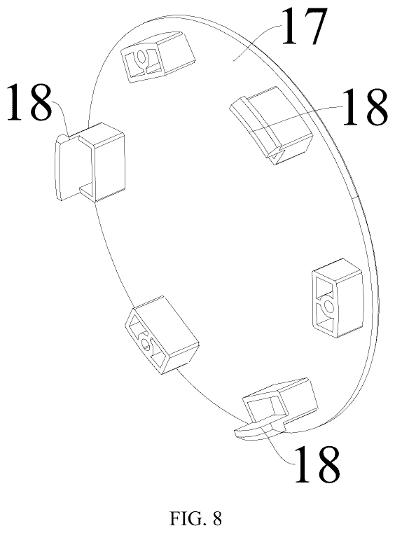

As shown in FIG. 1 to FIG. 8, in some embodiments of the present invention, a blocking cover 17 is provided on one side, close to the turbo fan 3, of the installation shell 2, and the blocking cover 17 is provided with a plurality of clamping hooks 18; and a side wall of the installation shell 2 is provided with a plurality of clamping holes 19, the clamping hooks 18 are embedded into the clamping holes 19, the blocking cover 17 is spaced apart from the installation shell 2, and the air inlet hole 5 is formed between the blocking cover 17 and the installation shell 2. According to the present invention, by providing the blocking cover 17, one side, close to the turbo fan 3, of the installation shell 2 is shielded by the blocking cover 17 to prevent external objects from touching the turbo fan 3 inside the installation shell 2, making it safer to use. Moreover, by providing the clamping hooks 18 and the clamping holes 19, when the blocking cover 17 is installed, the blocking cover 17 is installed on a side wall of the installation shell 2 by embedding the clamping hooks 18 into the clamping holes 19, making it easy to operate.

The above description only shows preferred embodiments of the present invention, and is not used for limiting the present invention. For person skilled in the art, the present application is obviously not limited to the details of the above exemplary embodiments, and the present application can be implemented in other specific forms without departing from the spirit or basic features of the present application.

Therefore, the embodiments should be regarded as exemplary and non-restrictive from any point of view, the scope of the present application is defined by the appended claims rather than the above description, and it is therefore intended that meanings of equivalent elements and all changes falling within the scope of the claims should be included within the present application. Any reference signs in the claims shall not be construed as limiting the claims concerned. For persons skilled in the art, the present invention may have various modifications and changes. Any modifications, equivalent substitutions, improvements and the like made within the spirit and principles of the present invention shall be included in the scope of protection of the present invention.

What is claimed is:

1. A neck-hanging air purifier, wherein the neck-hanging air purifier comprises a neck-hanging body and an installation shell provided on the neck-hanging body, the installation shell is internally provided with a turbo fan and a filter screen, an air inlet hole is provided on one side, close to the turbo fan, of the installation shell, and an air outlet is provided on one side, close to the filter screen, of the installation shell.

2. The neck-hanging air purifier according to claim 1, wherein the installation shell is provided with a protective mesh cover located at the air outlet.

3. The neck-hanging air purifier according to claim 2, wherein the protective mesh cover and the air outlet are both circular, the installation shell is provided with a plurality of clamping bumps located at the air outlet, and a side wall of the protective mesh cover is provided with a plurality of L-shaped clamping grooves; and the clamping bumps correspond to the clamping grooves one by one, and the clamping bumps are embedded into the clamping grooves.

4. The neck-hanging air purifier according to claim 2, wherein the neck-hanging air purifier further comprises an indicator rod, the protective mesh cover is provided with an insertion hole, and one end of the indicator rod is inserted into the insertion hole.

5. The neck-hanging air purifier according to claim 1, wherein the neck-hanging body is provided with an installation box, the installation box is internally provided with a battery, and the battery is electrically connected to the turbo fan.

6. The neck-hanging air purifier according to claim 5, wherein the neck-hanging body is U-shaped, and the installation shell and the installation box are respectively located at two ends of the neck-hanging body.

7. The neck-hanging air purifier according to claim 6, wherein connecting rods are provided at two ends of the installation shell, and the installation shell and the installation box are respectively provided on the connecting rods.

8. The neck-hanging air purifier according to claim 1, wherein a blocking cover is provided on one side, close to the turbo fan, of the installation shell, and the blocking cover is provided with a plurality of clamping hooks; and a side wall of the installation shell is provided with a plurality of clamping holes, the clamping hooks are embedded into the clamping holes, the blocking cover is spaced apart from the installation shell, and the air inlet hole is formed between the blocking cover and the installation shell.
